(19) United States
(12) Patent Application Publication
(10) Pub. No.: US 2012/0101940 A1
(43) Pub. Date: Apr. 26, 2012

(54) END-TO-END MONITORING OF A RETAIL PAYMENTS PROCESS

(75) Inventors: Theresa Brennan, Garnet Valley, PA (US); Williard H. Waldron, Charlotte, NC (US); Murali Santhanam, Naperville, IL (US); Melinda A. Hodge, Waxhaw, NC (US)

(73) Assignee: BANK OF AMERICA CORPORATION, Charlotte, NC (US)

(21) Appl. No.: 13/342,073

(22) Filed: Jan. 1, 2012

Related U.S. Application Data
(63) Continuation-in-part of application No. 12/183,842, filed on Jul. 31, 2008.
Application No. 12/183,842 is a continuation-in-part of application No. 12/200,165, filed on Aug. 28, 2008.

(51) Int. Cl. G06Q 40/00

(52) U.S. Cl. 705/39

(57) ABSTRACT

The Embodiments of the invention comprise computer program products, systems, and methods for monitoring a retail payments process where a financial institution receives check payments for various types of transactions, such as but not limited to credit card payments, mortgage payments, student loan payments, car payments, etc. The image capture machines capture images of the checks and the associated check data. The check images are grouped into batches based on the client (i.e. the paying bank, third-party processing entity) that the checks are sent to in order to receive payments from the paying bank. The grouped batches are electronically sent to the proper client for processing. The individual checks in the batch are posted and settled to the customer's account. The process is monitored based on client processing limits to track, identify, and fix any batch exceptions that occur during processing.

### PRIORITY CLAIM

This non-provisional Patent Application is a Continuation-in-Part of and also claims priority to patent application Ser. No. 12/183,842 titled “END-TO-END MONITORING OF A CHECK IMAGE RECEIVING PROCESS” filed on Jul. 31, 2008, and patent application Ser. No. 12/200,165 titled “END-TO-END MONITORING OF A CHECK IMAGE SEND PROCESS” filed on Aug. 28, 2008, both of which are assigned to the assignee hereof and hereby expressly incorporated by reference herein.

### FIELD

This invention relates generally to the field of process monitoring, and more particularly embodiments of the invention relate to systems, methods, and computer program products for monitoring a retail payment process from beginning to end.

### BACKGROUND

As known, checks are negotiable instruments drawn against deposited funds that order a bank to pay a specified amount of money to a specified person on demand. Check collection, or “check clearing,” facilitates payment by moving checks from the banks where the checks are deposited (“Receiving Banks”) to the banks on whose accounts the checks are drawn (“Paying Banks”), and then moving the payment in the opposite direction. This credits accounts at the Receiving Bank and debits accounts at the Paying Bank. The Federal Reserve participates in check clearing through its nationwide facilities, but many checks are cleared by private sector arrangement.

The passing of the Check Clearing for the 21^{st} Century Act (“Check 21”) by Congress allowed recipients of paper checks to create a digital version of the paper check called an Image Replacement Document (“IRD”). Under Check 21, IRDs, officially named “Substitute Checks,” became a legal substitute for original paper checks. The IRDs include front and back images of the original check, together with other data presented by magnetic ink character recognition (MICR) line along the bottom of the IRD, where such other data typically includes the routing and transit number, the check-writer's account number, and/or the dollar amount of the check.

Businesses and banks can work strictly with IRDs, transfer paper copies to IRDs, or in some cases use paper copies of the IRDs when exchanging the files between member banks, savings and loans, credit unions, services, clearinghouses, and the Federal Reserve Bank (“FED”). Banks also service various types of accounts for customers, such as but not limited to, credit cards, mortgages, student loan payments, car payments, etc. The payments received by the receiving bank may or may not include a coupon. A coupon is a payment stub that discloses information about the amount of the payment being made, the customer making the payment, the account to which to apply the payment, change of address information, etc. The payments are grouped together in batches and they are routed based on the client. Batches (i.e. cash letters) are groups of checks or potentially other negotiable instruments packaged and sent by a bank to another bank, clearinghouse, or FED office. A batch is accompanied by a list containing the dollar amount of each check in the batch, the total number of checks in the batch, and the total dollar amount of all the checks in the batch. The batch may also include instructions for transmitting the groups of checks or other negotiable instruments to other banks or businesses.

The clients to which the batches are sent, may all have different requirements as to when the transactions are to be processed, posted, settled, etc. Due to the variation in the requirements set by the receiving banks and/or the different clients (i.e. paying banks, third-party processing businesses, etc.) for processing, it becomes difficult to balance and track the batches and associated checks. Currently there is no end-to-end monitoring system under which a bank can monitor the retail payment processing from beginning to end. Under the current system, it is difficult to monitor the uncollected, failed, mishandled, etc. checks and/or batches, and then fix any processing issues when they are discovered. The need exists for a system that allows a bank or other financial institution to monitor checks, batches, and associated credits during processing from receipt of the retail payments to posting and settlement, in order to safeguard that the batches and associated checks have not been lost, misplaced, incorrectly processed, misscategorized, etc.

### BRIEF SUMMARY

Embodiments of the present invention address the above needs and/or achieve other advantages by providing a method, system, computer program product, or a combination of the foregoing for an end-to-end Business Activity Monitoring (BAM) solution for a retail payment process. Specifically, the present invention relates to monitoring processing metrics for a retail payment process comprising batches of checks, or other negotiable items, from time that the checks are received by a financial institution until the time that the checks are posted and settled to the proper accounts.

Embodiments of the invention comprise computer program products, systems, and methods for monitoring a retail payments process where a financial institution receives check payments for various types of transactions, such as but not limited to credit card payments, mortgage payments, student loan payments, car payments, etc. The image capture devices capture images of the checks and the associated check data. The check images are grouped into batches based on the client (i.e. the paying bank, third-party processing entity) that the checks are sent to in order to receive payments from the paying bank. The grouped batches are electronically sent to the proper client for processing. The individual checks in the batch are posted and settled to the customer's account. The process is monitored based on client processing limits to track, identify, and fix any batch exceptions that occur during processing.

Embodiments of the invention comprise a computer program product, system, and method for monitoring a payment process comprising monitoring the payment process in a dashboard from when at least one payment is received until the at least one payment is sent for posting and settlement. The dashboard displays at least one metric relating to processing the at least one payment illustrating if the processing metric has met or will meet a processing limit.

In further accord with an embodiment of the invention the at least one processing metric is a risk status determined based on a predicative analysis of likelihood that the processing metric is going to meet the processing limit in the future.

In another embodiment of the invention a status indicator is used to display if the processing metric has met or will meet the processing limit.

In yet another embodiment of the invention the processing limit is based on a client requirement.

In still another embodiment the at least one payment is a batch of payments that have been consolidated in the batch based on a client to which the payments are being sent for processing.

In further accord with an embodiment of the invention comprises receiving an image of the at least one payment, and receiving data related to the at least one payment.

In another embodiment of the invention, the invention further comprises performing an image quality assurance test on the image.

In yet another embodiment of the invention, the invention further comprises capturing an image of the at least one payment from a paper retail payment.

In still another embodiment of the invention, the invention further comprises capturing data related to the at least one payment from a paper retail payment.

In further accord with another embodiment of the invention, the invention further comprises capturing the at least one processing metric relating to processing the at least one payment, and comparing the at least one processing metric relating to processing the at least one payment to a processing limit.

In another embodiment of the invention, the processing metric is a processing start time, a processing end time, a processing duration, or a number of exceptions for at least one processing step in the payment process.

The features, functions, and advantages that have been discussed may be achieved independently in various embodiments of the present invention or may be combined in yet other embodiments, further details of which can be seen with reference to the following description and drawings.

### BRIEF DESCRIPTION OF THE SEVERAL VIEWS OF THE DRAWINGS

Having thus described embodiments of the invention in general terms, reference will now be made to the accompanying drawings, which are not necessarily drawn to scale, and wherein:

FIG. 1 provides a flow diagram illustrating a high level retail payment process, in accordance with an embodiment of the present invention;

FIG. 2 illustrates a process map outlining a more detailed retail payment process of the high level retail payment process described in FIG. 1, in accordance with an embodiment of the present invention;

FIG. 3 illustrates a financial institution retail payment system environment through which the retail payment process and monitoring occurs, in accordance with one embodiment of the present invention;

FIG. 4 illustrates a batch detail interface for the overall process summary of the end to end monitoring of retail payments, in accordance with one embodiment of the present invention;

FIG. 5 illustrates a batch search interface for researching batches that are processed at the various sites, in accordance with one embodiment of the present invention;

FIG. 6 illustrates an alarm interface for displaying the batches that are in danger of not meeting a threshold or baseline requirement, or for batches that have failed to meet the threshold or baseline requirements, in accordance with one embodiment of the present invention; and

FIG. 7 illustrates a research repository interface, which is used to research the batch exceptions for use in reporting, implementing fixes, and leveraging fixes for further batches, in accordance with one embodiment of the present invention.

### DETAILED DESCRIPTION OF EMBODIMENTS OF THE INVENTION

Embodiments of the present invention now will be described more fully hereinafter with reference to the accompanying drawings, in which some, but not all, embodiments of the invention are shown. Indeed, the invention may be embodied in many different forms and should not be construed as limited to the embodiments set forth herein; rather, these embodiments are provided so that this disclosure will satisfy applicable legal requirements. Like numbers refer to like elements throughout. Embodiments of the invention described herein are generally described as involving a “financial institution,” such as a bank; however, one of ordinary skill in the art will appreciate that other embodiments of the invention may involve other businesses or financial institutions that take the place of or work in conjunction with the financial institution to perform one or more of the processes or steps described herein as being performed by the financial institution.

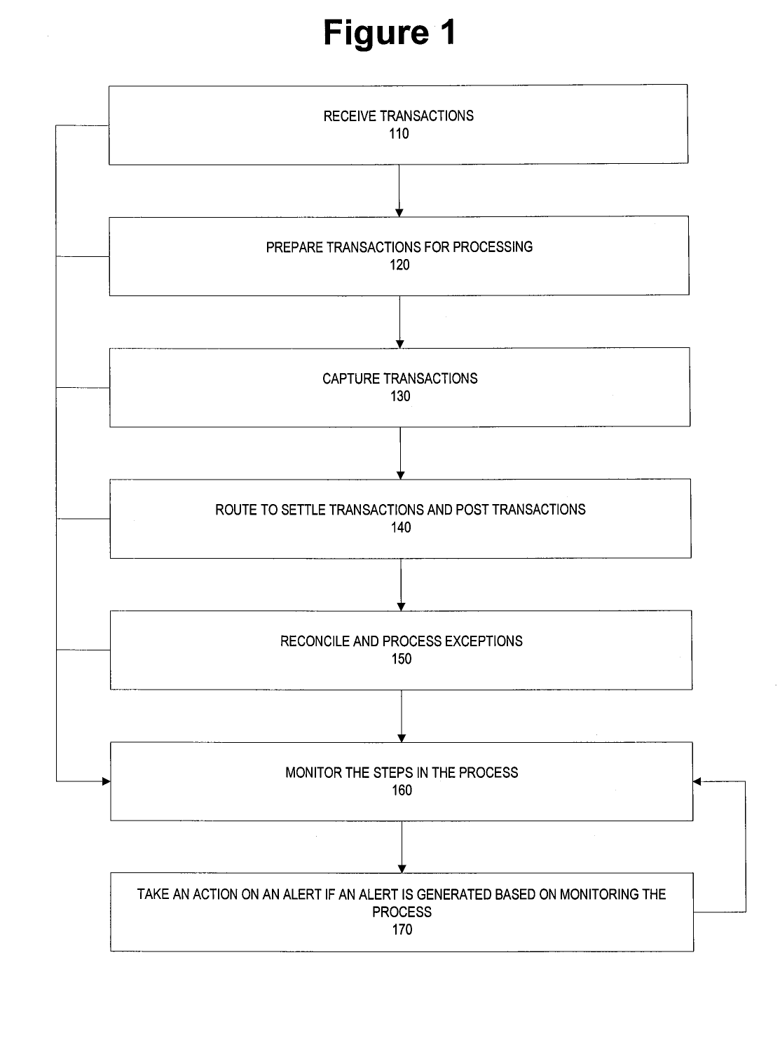

FIG. 1 provides a high level flow diagram illustrating the basic steps involved in the retail payment process in accordance with an embodiment of the present invention. As illustrated in block 110 of FIG. 1 the financial institution receives the transactions (i.e. retail payments). As previously discussed the retail payments are paper check payments for mortgages, car payments, loan payments, etc. The paper check payments are often received in the mail and include a coupon outlining some personal information of the person making the payment, such as the name, address, account number of the payment account, payment amount, etc. Thereafter, as illustrated in block 120 the transactions received (i.e. retail payments) are prepared for processing. In preparing the retail payments for processing the mail is opened and the checks and/or coupons are sorted in trays (i.e. bins, bags, etc.) for processing in image systems. The sorted checks and/or coupons are processed using the image capture devices in order to capture images and data from the checks and/or coupons, as illustrated by block 130 of FIG. 1. The captured retail payments are grouped into batches based on the clients for whom they are being processed. The captured retail payment images and data are routed in batches for settlement and posting as illustrated by block 140 in FIG. 1. Any images for individual check and batches that have processing errors are identified during the process as exceptions and are reconciled and processed using automatic or manual reconciliation processes, as illustrated by block 150 in FIG. 1. The retail payment process is monitored to identify any checks and/or batches that may not meet processing requirements or that may be found to be exceptions in processing throughout each of the steps and sub-steps of the retail payment process, as illustrated by block 150 in FIG. 1. As illustrated by block 160, if there are any batch exceptions an alert is created to notify a user 10 of the exception and the user takes an action on the alert to indicate that the alert is not an issue, has been fix, is in the process of being fixed, needs to be processed manually, etc. in order to record and track any exceptions and the corresponding actions taken on the batch exceptions.

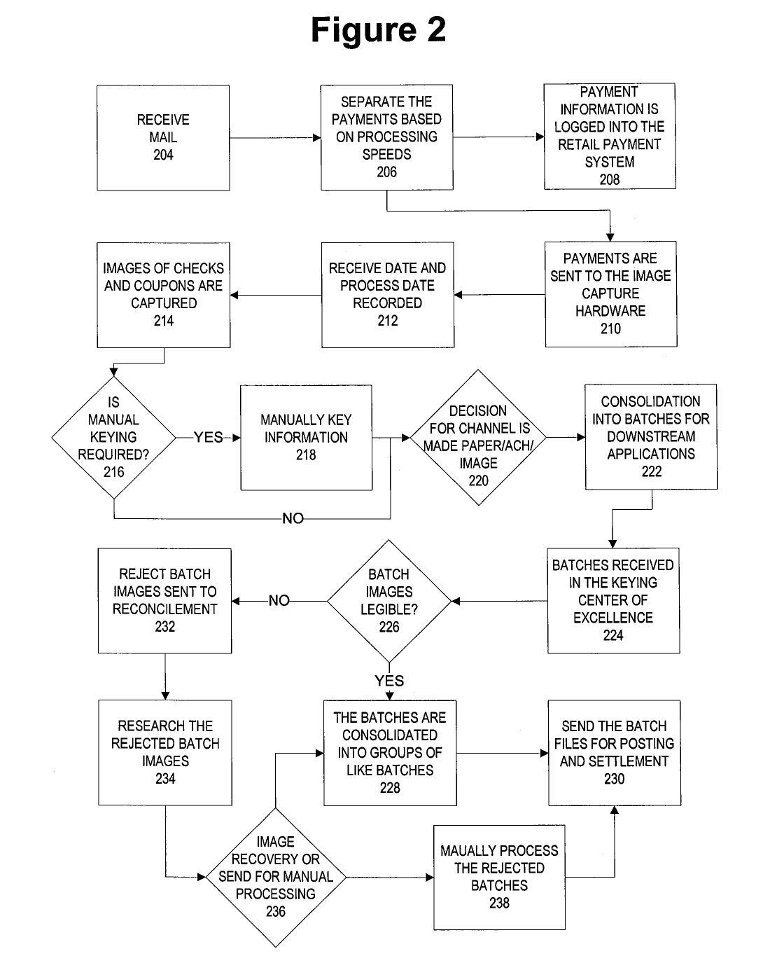

FIG. 2 provides a more detailed flow diagram illustrating the steps involved in the retail payment process, in accordance with an embodiment of the present invention. The steps illustrated in FIG. 2 are explained in more detail throughout this application below.

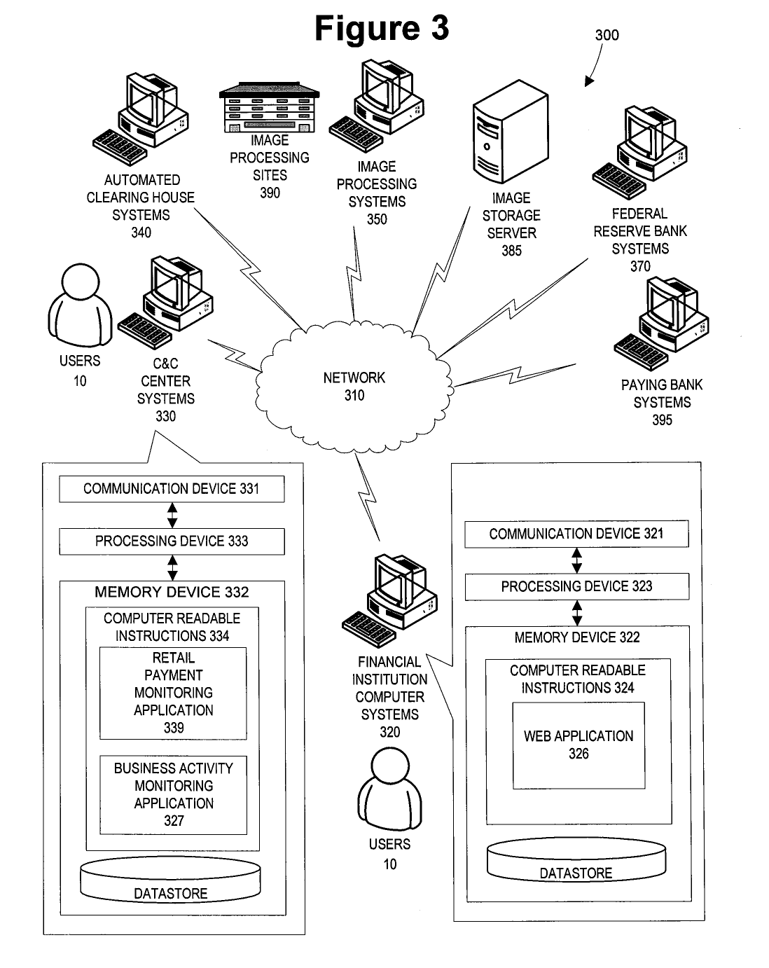

FIG. 3 illustrates a financial institution retail payment system 300 environment through which the retail payment process and monitoring of the retail payment process occurs, in accordance with one embodiment of the invention. As illustrated in FIG. 3, the financial institution environment includes a financial institution computing system 320 communicatively coupled, via a network 310, to a command and control (C&C) center 330, image processing systems 350 located at processing sites 390, image storage servers 385, paying bank systems 395, automated clearing houses (ACH) systems 340, Federal Reserve Bank systems 370, etc. In this way, the financial institution (i.e. receiving bank) can receive paper checks at the processing sites 390, capture images of the checks and associated data on the image processing systems 350, and send to, and receive from, the various systems electronic data regarding check images, batches, associated check and batch data, etc. The network 310 may be a global area network (GAN), such as the Internet, a wide area network (WAN), a local area network (LAN), or any other type of network or combination of networks. The network 310 may provide for wireline, wireless, or a combination of wireline and wireless communication between devices in the network.

In one embodiment of the invention, the financial institution C&C center systems 330 are used for monitoring the retail payment process and, potentially, other bank processes. Although FIG. 3 illustrates the C&C center systems 330 as a separate computing system from the financial institution's general financial institution computer systems 320, in other embodiments the C&C center systems 330 are part of the financial institution computing systems 320 or other systems within the financial institution that are used to monitor systems and process that the financial institution utilizes.

The C&C center systems 330 generally comprise a communication device 331, a memory device 332, and a processing device 333 operatively coupled to the communication device 331 and the memory device 332. The processing device 333 uses the communication device 331 to communicate with the network 310 and with users of the C&C computing system 330. As such, the communication device 331 generally comprises a modem, server, or other device(s) for communicating with other devices on the network 310 and a display, mouse, keyboard, microphone, and/or speakers for communicating with one or more users 10. As further illustrated in FIG. 3, the C&C center systems 330 includes computer-readable program instructions 334 stored in the memory device 332, which includes the computer-readable instructions 334 of a retail payment monitoring application 339. In other embodiments of the invention the C&C center systems 330 also comprise applications for monitoring other systems and processed used at the financial institution, such as but not limited to image receive processes, image send processes, other image or check processing systems and process related to other types of transactions that occur at the bank, etc.

As described in greater detail below, the retail payment monitoring application 339 presents real-time information about the retail payment system 300 and process 200 to a user 10 of the C&C center systems 330 in a way that makes it easy for the user 10 to continuously monitor the retail payment system 300 and process 200 in real time. In one embodiment, the retail payment monitoring application 339 of the C&C center systems 330 gets real-time information about the retail payment process 200 from the image processing systems 350 located at one or more image processing sites 390 within the financial institution, from financial institution computer systems 320, image storage servers 385, or other systems accessed through the network 310.

As described in greater detail below, the retail payment monitoring application 339 provides dashboards that display information about the retail payment system 300 and process 200. Specifically, the retail payment monitoring application 339 provides an end-to-end real-time view of the process of receiving and processing retail payments. Typically, the checks received for retail processing are grouped in batches (i.e. Image Cash Letters (ICLs)) and are tracked through the retail payment process, along with the associated images, data, metrics (e.g. current processing metrics, and predictive future processing metrics) based on the processing requirements for the clients for which the batches are being processed. The retail payment monitoring could also apply to other types of negotiable items that are processed by the financial institution. The metrics being monitored in some applications are the Critical to Quality metrics (CTQs) within the bank's infrastructure, applications, and processes, which can be monitored in real time.

In some embodiments the retail payment monitoring application 339 can pull, or be pushed, the CTQ data from other systems in the retail payment system 300. In some embodiments of the invention the C&C center systems 330, may also comprise a business activity monitoring application 327 that instructs the processing device 333 to monitor the CTQs within the bank's infrastructure, systems, servers, applications, and processes in real time and receive the data by pulling or having other systems push the CTQ data into one or more data stores in the memory device 332 and/or other systems on the network 310, which allow the retail payment monitoring application 339 to access the CTQ data for monitoring purposes. Therefore, the business activity monitoring application 327 may be used by the monitoring applications (i.e., the retail payment monitoring application 339) in the C&C center systems 330 to access and/or receive the data that a user 10 is interested in tracking In other embodiments of the invention, the retail payment monitoring application 339 and/or business activity monitoring application 327 may be located on other systems, such as but not limited to the financial institution computer systems 320.

As illustrated in FIG. 3, the financial institution computer systems 320 generally comprises a communication device 321, a memory device 322, and a processing device 323 operatively coupled to the communication device 321 and the memory device 322. The processing device 323 uses the communication device 321 to communicate with the network 310. As such, the communication device 321 generally comprises a modem, server, or other device for communicating with other devices on the network 310 and a display, mouse, keyboard, microphone, and/or speakers for communicating with one or more users 10. As further illustrated in FIG. 3, the financial institution computer systems 320 include computer-readable instructions 324 stored in the memory device 322 which includes the computer-readable instructions 324 of the a web application 326.

The web application 326 allows a user to access the monitoring applications, such as the retail payment monitoring application 339 stored in the C&C center system 330, in order to monitor and/or take action on the retail payment system 300 and process 200. For example, if the checks or batches do not meet a processing limit (e.g., tracking requirement, exception number, processing time, etc.) or are about to violate a processing limit, users 10 can access the retail payment monitoring application 339 and/or other systems and applications at the financial institution in order to identify, fix, and record the fix of the checks or batches that did not meet the processing limit.

As illustrated in FIG. 3, the retail payment system 300, comprises image processing systems 350. The image processing systems 350 have the same or similar devices as described with respect to the C&C center systems 330 and the financial institution computer systems 320. The devices allow the image processing systems 350 to communicate with the other systems on the network 310. In some embodiments of the invention the image processing systems 350 may be located in a central location or may be spread out across various locations. The image processing sites 390 receive paper checks and coupons (e.g., payment information slips) for retail payments in the mail, and the paper checks of the retail payments are processed through image processing systems 350 that contain or communicate with image capture devices. The retail payment monitoring application 339 identifies information regarding the images of the checks and associated data in order to make sure the checks are being processed according to the requirements of the clients with which the checks are associated.

In some embodiments of the invention, as illustrated in FIG. 3, the retail payment system 300 may comprise an image storage server 385. The image storage server 385 may receive electronic check data, including the check images and associated data related to the checks and coupons from the image processing systems 350 in order to store the electronic check image and data for further processing, transaction history information, customer access, etc. In some embodiments of the invention the image storage server 385 may be located on a separate system; however, in other embodiments it may be a part of one of the other systems connected through the network 310, such as the C&C center systems 330, the financial institution systems 320, the image processing systems 350, etc.

In some embodiments of the invention, as illustrated in FIG. 3, the retail payment system 300 may communicate with automated clearinghouse systems 340. The financial institution may need to send check images or batches of the retail payments received and captured at the image processing sites 390 to automated clearinghouse systems 340 in order to process the retail payments for various institutions (e.g., for financial institutions that do not have image processing capabilities, etc.).

In some embodiments of the invention, as illustrated in FIG. 3, the retail payment system 300 may communicate with Federal Reserve Bank systems 370. The financial institution may need to send check images or batches of the retail payments received and captured at the image processing sites 390 to the Federal Reserve Bank systems 370 in order to process the retail payments.

In some embodiments of the invention, as illustrated in FIG. 3, the retail payment system 300 may communicate with paying bank systems 395. The financial institution may need to send check images or batches of the retail payments received and captured at the image processing sites 390 to the paying bank systems 395 in order to process the retail payments.

Referring again to FIG. 2, as described above, FIG. 2 illustrates a process map of one embodiment of the invention outlining the steps from first receiving the retail payments at the processing sites 390 to posting and settlement of the retail payments.

As illustrated by block 204 the financial institution receives mail containing the retail payments. In some embodiments the retail payments may be sent directly to the individual image processing sites 390 that are responsible for capturing the images and the associated data related to the retail payments, or in other embodiments of the invention the retail payments may be sent to a mail processing site and thereafter sent to the appropriate image processing sites 390.

The envelopes received in the mail are stored based on thickness detection, such that single checks and coupons (e.g., the thinner mail) can be opened and captured by high speed image capture devices, while envelops that are thicker (e.g., other types of payments with multiple checks and coupons, other payments types) can be processed on slow speed capture devices, as illustrated by block 206. As illustrated in block 208 of FIG. 1, the retail payment information, regarding the checks and/or coupons being processed are logged into the retail payment systems, such as but not limited to the time at which the checks and/or coupons were received, the time they were entered into the image capture device for processing, the number of checks being processed, etc.

As illustrated by block 210 in FIG. 2, the payments (i.e., checks and/or coupons) are sent to the image capture devices for processing. The operator of the image capture devices (or other employee, user 10, etc.), captures the data (i.e. date, time, number, etc.) related to receiving and processing the retail payments as illustrated by block 212 of the retail payment process 200 illustrated in FIG. 2. The image capture devices capture images of the retail payments, such as the back and front of the checks and/or coupons, as illustrated in block 214, as well as data such as the account number, payment amount, check miro information, etc. The images and associated data are used to process the retail payments through the retail payment system 300 and other systems.

As illustrated in decision block 216, a determination is made if the images require manual keying, which primarily involves keying in the proper check payment amount (or other data) if the data could not be captured by the image capture devices. As illustrated by block 218, if manual keying is necessary the appropriate information is keyed into the retail payment system 300. After the manual information is keyed or if manual keying is not required, as illustrated by the decision block 220, the appropriate channel for processing the retail payments is determined. The images may be further processed using paper processing procedures, automated clearing house procedures, image exchange processing procedures with paying bank systems 395, etc. As illustrated by block 222, after the processing channel is determined for the retail payments, the retail payments are grouped and consolidated into batches (e.g., image cash letters) for downstream processing. As previously discussed the batches of retail payments are grouped based on how the financial institution and/or the associated clients are going to process the retail payments, the client to which the financial institution is sending the retail payments, the channel that the financial institution uses to send the batch files, etc. In some embodiments the batches are assigned a consolidation ID, which allows like batches to be grouped together into a set of files in preparation for being transmitted downstream to the clients. The batches, for example, can be consolidated into two or more batches that are going to be sent to a single client.

As illustrated by block 224 in FIG. 2 the batches are received in the keying center of excellence. The keying center of excellence determines if the images captured of the retail payments are acceptable for use in processing the retail payments. As illustrated by decision block 226, the keying center of excellence determines if the batch images are legible. If they are determined to be legible the batches are consolidated together into a set of files in preparation to be transmitted to the downstream clients. The batches are consolidated for delivery to clients on a strict schedule so that customers are timely credited and the financial institution recovers the funds from the clients for the retail payments, as illustrated by block 228. If a batch in the consolidation files has not completed processing by the consolidation schedule deadline, the batch exception can cause the whole set of associated batches from being sent downstream, and thus preventing the customer from being timely credited and the financial institution from receiving the payment from the clients. For example, one client may require that the batches be sent for processing by noon, while other clients may require that batches be sent for processing by five o'clock pm, by midnight, etc. If the batches have not completed processing by the client's deadlines then a whole group of consolidated batches may not get processed until the following day or until the batch exception is fixed. Thereafter, when the batches have been properly processed at the financial institution and the images within the batches are acceptable (e.g., are legible, have the proper associated data, etc.), the batches are sent to the proper client and posted and settled to the customer's account, as illustrated by block 230.

Alternatively, if the batch images are not legible they are rejected and sent for reconcilement, as illustrated by block 232. In reconcilement, as illustrated by block 234, the batches that were rejected are researched to determine how to reconcile the rejected batches. As illustrated by decision block 236, if the batch images can be recovered and used for processing then the images and associated data can be sent to posting and settlement as illustrated by blocks 228 and 230. If the image cannot be recovered by reconcilement the batch image may be processed manually by a user 10, as illustrated by block 238. After manual processing of the batch, the batch is sent for posting and settlement, as illustrated by block 230.

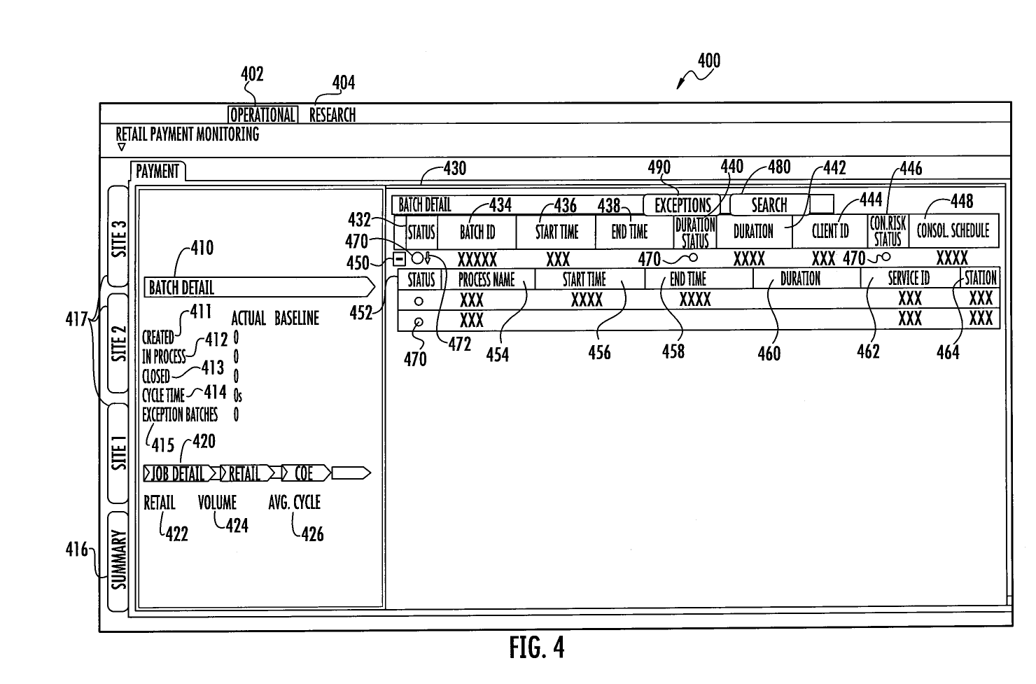

Along each of these steps in the retail payment process the batches are tracked for various information like identification information, such as but not limited to the batch ID, client ID, number of items in the batch, etc., and batch processing data such as but not limited to processing start time, processing end time, duration of processing, risk status (based on client requirements), consolidation schedule, process step at which the batch is currently located, etc. The identification information and the batch processing data is illustrated throughout interfaces in the retail payment monitoring application 339 as described below and illustrated with respect to FIGS. 4 through 7.

FIG. 4 illustrates a batch detail interface 400, illustrating an overall retail payment processing summary of the sites at which the retail payments are received for processing. In some embodiments, as illustrated in FIG. 4, the batch detail interface 400 comprises three zones, the batch detail zone 410, the job detail zone, 420, and the exception zone 430. The batch detail zone 410 may display actual, as well as baseline values for various check processing metrics for one or more processing sites. For example, in some embodiments, the batch detail zone 410 may include metrics for the number batches created 411, the batches in process 412, the batches closed 413, the cycle time 414, and the exception batches 415. The batches created 411 illustrate the number of batches created from the retail payments received in the image processing systems 350. The batches in process 412 illustrate the number of batches of retail payments currently being processed. The batches closed 413 illustrate the number of batches that completed being processed and have been sent to the client for posting and settlement. The cycle time 414 illustrates the time (i.e. average time) that the batches have been in process, which may be determined based on all the batches, the batches in process, the batches that have been completed, etc. The exception batches 415 illustrate the number of batches that have been identified as having a processing issue, such as but not limited to image capture issues, such as but not limited to illegible images, image formatting issues, etc. or issues with the associated data, such as but not limited to, no client information, no account information, no account holder information, no payment information, no client information, etc. The batch detail zone 410 may illustrate the metrics for all of the processing sites together by selecting the summary icon 416, or for each individual processing site by selecting the site icon 417 for site 1, site 2, or site 3, etc.

The batch detail zone 410 may illustrate the metrics as the actual values, as well as the baseline values to which the metrics should meet. The baseline values may illustrate on average for a particular time, hour, day, week, etc. the value that the metrics should be achieving to be within the tolerance levels. In some embodiments, if a user 10 sees that the actual values do not meet, or are not on track to meet, the baseline values, then the user 10 may be alerted to the fact that there is a processing issue associated with a batch of images or a single image within a batch. The user 10 may be alerted to an issue by viewing the dashboards or by receiving a notification alert, as explained in further detail below. Furthermore, in some embodiments the user 10 can capture how an issue with the batch was resolved by accessing the alarm dashboard and recording information about the resolution of the issue in order to resolve similar issues in the future.

The job detail zone 420 displays additional metrics related to specific processing jobs within the specific sites (i.e. site 1, site 2, site 3, etc.), such as the retail payments received 422, the volume of payments 424, and the average cycle time 426 for the payments for the particular job within a specific site.

The exception zone 430 displays data related to the batches that have been identified as having processing issues, such as but not limited to exceeding defined processing threshold times, having illegible images, etc. In some embodiments the exception zone 430 illustrates all of the exceptions being processed, the exceptions processed at a particular site, exceptions processed for a particular job, exception processing during a particular time or period of time, etc. The exception zone illustrates the batch status 432, the batch ID 434, the batch start time 436, the batch end time 438, the batch duration status 440, the batch duration 442, the batch client 444, the batch risk rating 446, the batch consolidation schedule 448, and a job detail icon 450.

The batch status 432 displays the overall status of the batch in terms of an indicator 470. In some embodiments of the invention the indicator 470 may be a color coded identifier that displays a green color if a metric is acceptable, a yellow color if a metric is indicating a warning, and a red color if a metric is critical. In some embodiments, the indicator 470 icon may change to convey various messages, such as within a threshold, approaching threshold, and exceeding the threshold (or other categories of messages). The indicator 470 may also comprise a notification, such as but not limited to an arrow 472 on the right of the indicator 470 tells the user when the exception is being generated by a specific job and requires further investigation. The indicator 470 can be an indicator other than color coded, such as a number indicator (e.g., rank, percentage), an indicator icon (e.g., picture, etc.), or any other type of indicator that can be used to display the status of the a metric related to processing the batch.

The batch ID 434 is the primary identification information for a batch supplied by the image processing sites 390. The batch ID 434 is used to allow a user to identify information about the batch. In some embodiments, the batch ID 434 itself provides information regarding where the batch was processed, to which client it is being sent for posting and settlement, when it was processed, etc.

The batch start time 436 displays when the processing began on the batch exceptions for each of the job(s), for the processing sites 390, and/or for the total end-to-end process. The batch start time 436 may be derived as the retail payment system begins the first part of processing of the retail payment. The batch end time 438 may be the time at which the batch exception completed the last processing step (e.g., done time, out time, etc.). The batch end time 438 may be derived from the batch attaining the done status (e.g., the end of the processing of the batch within the financial institution), or from the out time (e.g., sent to the client for further processing). The done time and the out time may or may not happen simultaneously.

The batch duration 442 monitors the age of the batch in real time. The batch duration begins tracking at the start time and is a live counter until the process reaches the done status after the batch end time 438.

The batch client ID 444 is the client identifier for which the batch is being processed. The batch client ID 444 may be important as it is used to determine the client requirements associated with when the batch needs to complete processing in order to be included in the consolidation files and meet the client requirements for processing and delivery. Different batch clients have different client requirements for processing and consolidation, and thus one batch with a specific processing duration 442 may be violating the client processing requirements while a second batch with the same specific processing duration 442 may not be violating the client processing requirements.

The batch risk rating 446 is a risk rating determined for a batch based on how close the consolidation time for the batch is as compared to the processing limit required by the client. As an open batch gets closer to the provided consolidation time the risk rating may progress from acceptable to a warning, and then to a critical status if it passes the consolidation time threshold. As this occurs, notification alerts, such as automated e-mail alerts, etc., are sent to the appropriate users 10 (i.e. employees, business partners, etc.) to promote that an action be taken on the batch exception to remediate, fix, close, etc. the batch.

The batch consolidation schedule 448 illustrates when a particular batch is scheduled for consolidation with other like batches for delivery to the client. The consolidation schedule in some embodiments is determined based on the requirements of the clients for which the batch is being processed. The users 10 of the retail payment monitoring system 300 can sort batches by this field to create a priority list of the batch exceptions that should be researched and fixed first so that the delivery of batches to the client on time can occur on time.

In some embodiments of the invention, the users of the retail payment monitoring system can drill down into more detail about the specifics of the batch exceptions. For example, there may be a symbol (i.e., +, ×, etc.) to view more detailed specifics regarding the batch exceptions in relation to a particular job within a site or process that the batch has completed, is in process of completing, or has yet to complete. For each batch exception, the additional information may include a batch job status 452, the job step 454, the job start time 456, the job end time 458, the job duration 460, the job service ID 462, the job station 464, etc. The job status 452, as is the case with the batch status 432, provides an indicator 470 that reflects the processing status of each step, for example, through the use of a job icon (i.e. color scheme, number scheme, letter scheme, etc.). In some embodiments an indicator 470 could simply be text describing the status of the batch. The job step 454 illustrates the specific job of the process for which the information is being provided. The job start 456 and end time 458 illustrates the actual start and end time of the specific jobs referenced with respect to the particular batch being processed. The job duration 460 illustrates a live counter based on the start time of the job that illustrates how long the batch has been in the particular job. In some embodiments of the invention, when the job of the process is completed the job duration 460 illustrates the difference between the job start time 456 and end times 458. The service ID 462 illustrates the associated ID or the queue, of the job in which the batch is currently located, was last associated with, or will be associated with in the future. The station 464 illustrates the machine (e.g., image capture device, computer system, etc.) for the job on which the retail payments, batches, consolidated batched, etc. are being processed. Thus, a user 10 can track potential issues down to the specific machines that are processing the retail payments.

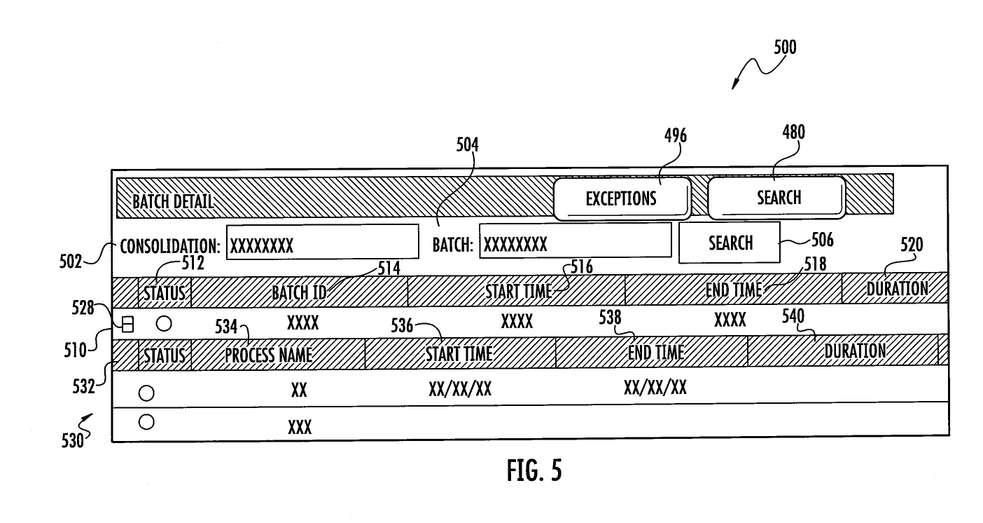

FIG. 5 illustrates a batch search interface 500. A user can access the search interface 500 by selecting the batch search icon 480 in the batch detail interface 400. The search interface allows a user to research any batch processed within a time frame (e.g., all batches ever processed, batches processed in a year, batches processed in a week, batches processed during the day, batches processed in the last hour, etc.). The batch search interface 500 includes a consolidation entry 502, a batch entry 504, a search icon 506, and a results zone 510. The results zone 510 includes a batch status 512, a batch ID 514, a batch start time 516, a batch end time 518, and a batch duration 520. The results zone 510 also includes a drill down icon 528 that allows a user to identify more information about the jobs related to a particular batch. The drill down icon 528 when selected provides a job zone 530, which displays the job status 532, the job step 534, the job start time 536, the job end time 538, and the job duration 540. In some embodiments the metrics displayed in the results zone 510 and the job zone 530 are the same or similar metrics as previously discussed with respect to the batch detail interface 400. The batch search interface 500 allows a user to search for a particular batch ID or consolidation ID (e.g., a particular group of batches) and retrieve information about the batch being processed at a batch level or as a function of the steps of the process. A user can search for a specific consolidation or batch by entering the search terms into the consolidation entry 502 and/or batch entry 504 and selecting the search icon 506. The user may review the results of the search in the batch search interface 500. The user can return to the batch detail interface 400 by selecting the exceptions icon 490.

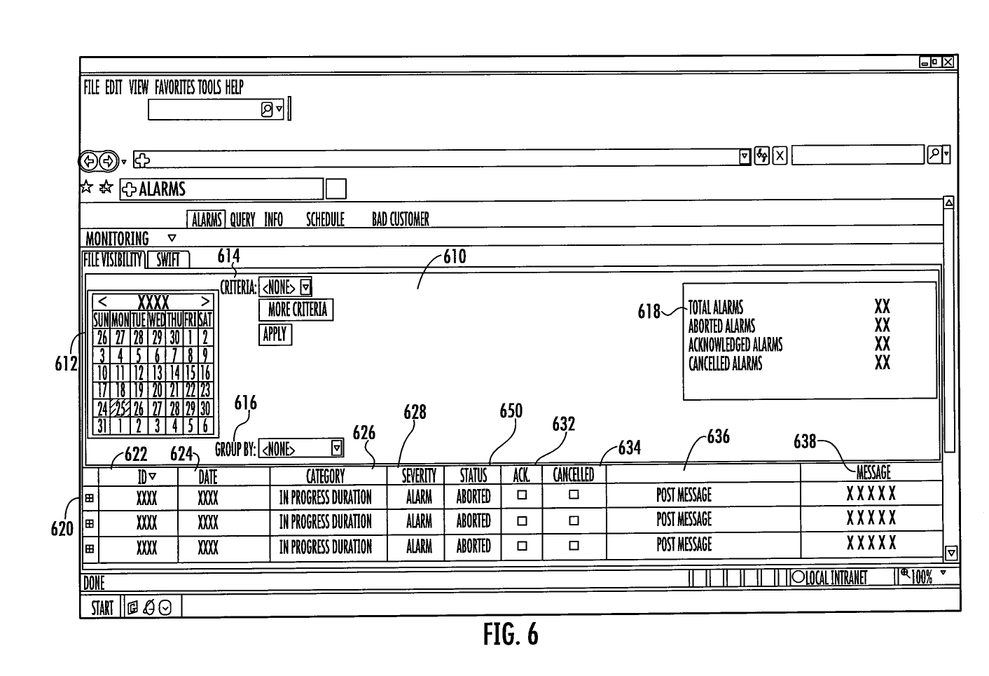

FIG. 6 illustrates an alarm interface 600. The alarm interface 600 displays the batches that are in danger of not meeting the processing limits (e.g., baseline requirements for processing), or that have failed to meet the processing limits. The alarm interface may include an alarm summary zone 610 and an alarm detail zone 620. The alarm summary zone 610 may comprise a calendar icon 612, a criteria selection 614, a grouping selection 616, and an alarm summary section 618. The alarm summary zone 610 allows a user to search for alarms based on the current day or days in the past using the calendar icon 612. The user can also use the criteria selection 614 and the grouping section 616 to search, weed out, organizine, and present the alarms in which the user may be interested. The alarm summary section 618 illustrates the total alarms received, the alarms that were aborted, the acknowledged alarms, and the cancelled alarms.

The alarm detail zone 620 illustrates the batch ID 622, the batch date and time 624, the alarm category 626, the alarm severity 628, the alarm status 630, the alarm acknowledgement 632, the alarm cancelation 634, the alarm message, etc. These alarms can be viewed by users 10 of the retail payment monitoring system 300, so that the users can track the any issue that occurs with any of the batches being processed. In some embodiments, the alarms may also be sent as notification alerts to employees within the bank (or outside of the bank at partners, contractors, etc.) to identify that a batch has an issue. The users, in some embodiments, may be required to take an action with respect to an alarm in order to indicate the status of an alarm. For example, the alarm may be marked as false, acknowledged, being fixed, in process, aborted, canceled, completed, fixed, closed, unknown, or associated with some other action in order to indicate the status of the batch associated with the alarm. In some embodiments of the invention the user 10 may be able to add comments to the status to provide additional information related to the status (e.g., how the issue was fixed) for future users 10 investigating the same issues. In some embodiments of the invention, the status can be illustrated in an indicator 470 throughout one or more the dashboards in the retail payment monitoring application 339. The retail payment monitoring system 339 may also track what user 10 took an action on an alert. Reports may also be generated by users 10 illustrating the batches processed, the batch exceptions, the open batches, the batch alerts and statuses, etc. for providing information related to the batches to various users 10 inside or outside (e.g., business partners) of the financial institution.

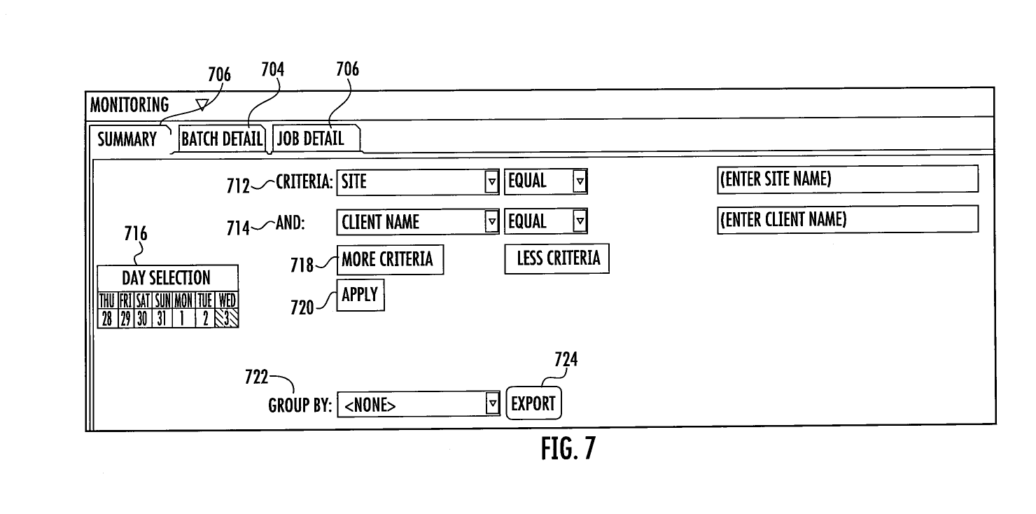

FIG. 7 illustrates a research repository interface 700. The research repository interface 700 allows a user 10 to research the batch exceptions for utilization in reporting, implementing fixes, and leveraging the fixes for future exceptions. In some embodiments of the invention the research repository interface 700 may have three sections: a summary tab 702, a batch detail tab 704, and a job detail tab 706. The research repository interface 700 may be used to query data that has been collected by the C&C center regarding the monitoring process of the retail payment system 300. This is done via selecting the tab related to the level of data needed. For example, a user could select the summary tab 702. The summary tab may include a criteria selection 712, and additional selections 714, a date selection 716 (or date range selection). The criteria selection 712 may include the site at which the processing took place, client name, batch identification number, batch processing data, or any metric related to the batches, etc. The additional selections 714 may include the same selections provided in the criteria selection 712, such as the site at which the processing took place, client name, batch identification number, batch processing data, or any metric related to the batches, etc. so that the user 10 can search for batch exceptions using multiple criteria. The date selection 716 may be the date with which the target data being searched occurred. A user 10 can use the research repository interface 700 to search, for example, summary batch data for a client at a specified site for a particular business day. To do this, the user 10 may click on the Summary tab 702, select a date from the calendar date selection 716, choose the site in the criteria selection 712 and enter the site name, select the more criteria icon 718 and in the additional selections 714 drop down that appears choose a client name and enter the appropriate client name, and then select the apply icon 720. The research repository interface 700 may provide data related to the batches that meet the search criteria. The data may be sorted by any heading, aggregated by any of the searchable options in the group selection 722, and exported by clicking the export icon 724.

Searching in the summary tab 702 provides information about the batch as previously described, for example, the batch volumes and cycle times by site, client detail, business day, processing line of business, etc. Searching using the batch detail tab 704 may be done the same as or similar to the summary tab 702. Searching the batch detail tab 704 provides information about the batches as previously described, for example, high level information relating to batches processed at the sites, batch ID, batch start date and time, batch end date and time, batch duration, batch client name, batch risk, batch exception status, etc. Searching using the job detail tab 706 may be done the same as or similar to the summary tab 702 and/or the batch detail tab 704. Searching using the job detail tab 706 provides information about the jobs for a batch as previously described, for example, batch ID, batch date, batch client ID, client Name, processing site, job name, job start date and/or time, job end date and/or time, job duration, job cycle time, job status service ID and Station, etc. Using the batch detail tab 704 or job detail tab 706 provides the same functions as described in the summary tab 702, but the criteria selection 712, additional selection 714, and group selection 722 options can be updated with the appropriate drop down options based on the data collected for each batch and job.

Throughout all the dashboards there are status indicators 470 represented by circles. These status indicators 470 may be color coded to provide the user of the dashboards with instant visual identification of the status of a particular exception, file, credit, metric, or other information located in the dashboard. For example, in one embodiment a red status indicator 470 may let the user know that a particular file is out of the processing limits, while a yellow status indicator 470 is a warning that a file is close to being out of the processing limits, and a green status indicator 470 lets the user know the file is within the processing limits. The status indicators 470 can be used with any information located in the dashboard to alert the user to the status of the information provided. The status indicators 470 do not have to be represented by circles and colors. The status indicators 470 may be any type of indicator, such as a symbol, icon, text, graphic, etc. to illustrate that status of a metric being tracked by the retail payment monitoring application 339.

As will be appreciated by one of skill in the art, the present invention may be embodied as a method, system, computer program product, or a combination of the foregoing. Accordingly, embodiments of the present invention may take the form of an entirely hardware embodiment, an entirely software embodiment (including firmware, resident software, micro-code, etc.), or an embodiment combining software and hardware aspects that may generally be referred to herein as a “system.” Furthermore, embodiments of the present invention may take the form of a computer program product comprising a computer-usable storage medium having computer-usable program code/computer-readable instructions embodied in the medium.

Any suitable computer-usable or computer-readable medium may be utilized. The computer usable or computer readable medium may be, for example but not limited to, an electronic, magnetic, optical, electromagnetic, infrared, or semiconductor system, apparatus, device, or propagation medium. More specific examples (a non-exhaustive list) of the computer-readable medium would include the following: an electrical connection having one or more wires; a tangible medium such as a portable computer diskette, a hard disk, a random access memory (RAM), a read-only memory (ROM), an erasable programmable read-only memory (EPROM or Flash memory), a compact disc read-only memory (CD-ROM), or other tangible optical or magnetic storage device; or transmission media such as those supporting the Internet or an intranet. Note that the computer-usable or computer-readable medium could even be paper or another suitable medium upon which the program is printed, as the program can be electronically captured, via, for instance, optical scanning of the paper or other medium, then compiled, interpreted, or otherwise processed in a suitable manner, if necessary, and then stored in a computer memory.

In the context of this document, a computer-usable or computer-readable medium may be any medium that can contain, store, communicate, propagate, or transport the program for use by or in connection with the instruction execution system, platform, apparatus, or device. The computer-usable medium may include a propagated data signal with the computer-usable program code embodied therewith, either in baseband or as part of a carrier wave. The computer-usable program code may be transmitted using any appropriate medium, including but not limited to the Internet, wireline, optical fiber cable, radio frequency (RF) or other means.

Computer program code/computer-readable instructions for carrying out operations of the present invention may be written in an object oriented, scripted or unscripted programming language such as Java, Perl, Smalltalk, C++ or the like. However, the computer program code/computer-readable instructions for carrying out operations of the invention may also be written in conventional procedural programming languages, such as the “C” programming language or similar programming languages.

Embodiments of the present invention are described above with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer-readable memory that can direct a computer or other programmable data processing apparatus to function in a particular manner, such that the instructions stored in the computer readable memory produce an article of manufacture including instruction means which implement the function/act specified in the flowchart and/or block diagram block or blocks.

The computer program instructions may also be loaded onto a computer or other programmable data processing apparatus to cause a series of operational steps to be performed on the computer or other programmable apparatus to produce a computer implemented process such that the instructions which execute on the computer or other programmable apparatus provide steps for implementing the functions/acts specified in the flowchart and/or block diagram block or blocks. Alternatively, computer program implemented steps or acts may be combined with operator or human implemented steps or acts in order to carry out an embodiment of the invention.

Embodiments of the present invention further provide a plurality of dashboards to be displayed using a display device communicatively coupled to a computing device. The figures provided herein illustrate examples of such dashboards. These dashboards are generated and operated by a processor executing computer-readable program instructions embodied in a computer-readable medium.

Specific embodiments of the invention are described herein. Many modifications and other embodiments of the invention set forth herein will come to mind to one skilled in the art to which the invention pertains having the benefit of the teachings presented in the foregoing descriptions and the associated drawings. Therefore, it is to be understood that the invention is not to be limited to the specific embodiments disclosed and that modifications and other embodiments and combinations of embodiments are intended to be included within the scope of the appended claims. Although specific terms are employed herein, they are used in a generic and descriptive sense only and not for purposes of limitation.

What is claimed is:

1. A system for monitoring a payment process, comprising:
a computer-readable medium providing computer-readable instructions; and
a processor operatively coupled to the computer-readable medium, wherein the processor is configured to execute the computer-readable instructions to:
monitor the payment process in a dashboard from when at least one payment is received until the at least one payment is sent for posting and settlement; and
wherein the dashboard displays at least one metric relating to processing the at least one payment illustrating if the processing metric has met or will meet a processing limit.

2. The system of claim 1, wherein the at least one processing metric is a risk status determined based on a predicative analysis of likelihood that the processing metric is going to meet the processing limit in the future.

3. The system of claim 1, wherein a status indicator is used to display if the processing metric has met or will meet the processing limit.

4. The system of claim 1, wherein the processing limit is based on a client requirement.

5. The system of claim 1, wherein the at least one payment is a batch of payments that have been consolidated in the batch based on a client to which the payments are being sent for processing.

6. The system of claim 1, wherein the processor is further configured to execute the computer-readable instructions to:
receive an image of the at least one payment;
receive data related to the at least one payment;

7. The system of claim 6, wherein the processor is further configured to execute the computer-readable instructions to:
perform an image quality assurance test on the image.

8. The system of claim 1, wherein the processor is further configured to execute the computer-readable instructions to:
capture an image of the at least one payment from a paper retail payment.

9. The system of claim 1, wherein the processor is further configured to execute the computer-readable instructions to:
capture data related to the at least one payment from a paper retail payment.

10. The system of claim 1, wherein the processor is further configured to execute the computer-readable instructions to:
capture the at least one processing metric relating to processing the at least one payment; and
compare the at least one processing metric relating to processing the at least one payment to a processing limit.

11. The system of claim 1, wherein the processing metric is a processing start time, a processing end time, a processing duration, or a number of exceptions for at least one processing step in the payment process.

12. A method for monitoring a payment process, comprising:
monitoring, through the use of a processing device, the payment process in a dashboard from when at least one payment is received until the at least one payment is sent for posting and settlement; and
wherein the dashboard displays at least one processing metric relating to processing the at least one payment illustrating if the processing metric has met or will meet a processing limit.

13. The method of claim 12, wherein the at least one processing metric is a risk status determined based on a predicative analysis of likelihood that the processing metric is going to meet the processing limit in the future.

14. The method of claim 12, wherein a status indicator is used to display if the processing metric has met or will meet the processing limit.

15. The method of claim 12, wherein the processing limit is based on a client requirement.

16. The method of claim 12, wherein the at least one payment is a batch of payments that have been consolidated in the batch based on a client to which the payments are being sent for processing.

17. The method of claim 12, further comprising:
receiving an image of the at least one payment; and
receiving data related to the at least one payment;

18. The method of claim 17, further comprising:
performing an image quality assurance test on the image.

19. The method of claim 12, further comprising:
capturing an image of the at least one payment from a paper retail payment.

20. The method of claim 12, further comprising:
capturing data related to the at least one payment from a paper retail payment.

21. The method of claim 12, further comprising:
capturing the at least one processing metric relating to processing the at least one payment; and
comparing the at least one processing metric relating to processing the at least one payment to a processing limit.

22. The method of claim 12, wherein the processing metric is a processing start time, a processing end time, a processing duration, or a number of exceptions for at least one processing step in the payment process.

23. A computer program product for allowing a user to monitor a payment process, the computer program product comprising at least one non-transitory computer-readable medium having computer-readable program code portions embodied therein, the computer-readable program code portions comprising:
an executable portion configured for monitoring the payment process in a dashboard from when at least one payment is received until the at least one payment is sent for posting and settlement; and
wherein the dashboard displays at least one processing metric relating to processing the at least one payment illustrating if the processing metric has met or will meet a processing limit.

24. The computer program product of claim 23, wherein the processing metric is a risk status determined based on a predicative analysis of likelihood that the processing metric is going to meet the processing limit in the future.

25. The computer program product of claim 23, wherein a status indicator is used to display if the processing metric has met or will meet the processing limit.

26. The computer program product of claim 23, wherein the processing limit is based on a client requirement.

27. The computer program product of claim 23, wherein the at least one payment is a batch of payments that have been consolidated in the batch based on a client to which the payments are being sent for processing.

28. The computer program product of claim 23, wherein the computer-readable program code portions further comprise:
an executable portion configured for receiving an image of the at least one payment; and
an executable portion configured for receiving data related to the at least one payment;

29. The computer program product of claim 28, wherein the computer-readable program code portions further comprise:
an executable portion configured for performing an image quality assurance test on the image.

30. The computer program product of claim 23, wherein the computer-readable program code portions further comprise:
an executable portion configured for capturing an image of the at least one payment from a paper retail payment.

31. The computer program product of claim 23, where the computer-readable program code portions further comprise:
an executable portion configured for capturing data related to the at least one payment from a paper retail payment.

32. The computer program product of claim 23, wherein the computer-readable program code portions further comprise:
an executable portion configured for capturing the at least one processing metric relating to processing the at least one payment; and
an executable portion configured for comparing the at least one processing metric relating to processing the at least one payment to a processing limit.

33. The computer program product of claim 23, wherein the processing metric is a processing start time, a processing end time, a processing duration, or a number of exceptions for at least one processing step in a payment process.
